(19) United States
(12) Patent Application Publication
(10) Pub. No.: US 2016/0174467 A1
(43) Pub. Date: Jun. 23, 2016

(54) A DOUBLE BLADE BAR FOR PRUNING AND POLLARDING, PARTICULARLY FOR OLIVE TREE GROVES, CITRUS GROVES, HEDGES, TIMBER TREES AND SIMILAR

(71) Applicant: OFFICINA MECCANICA DI BRAGANTI EMILIO & GONFIA PIERPAOLO S.N.C., Citta di Castello (PG) (IT)

(72) Inventors: Emilio BRAGANTI, Citta di Castello (PG) (IT); Pierpaolo GONFIA, Citta di Castello (PG) (IT)

(21) Appl. No.: 14/392,171

(22) PCT Filed: Jun. 24, 2013
(86) PCT No.: PCT/IB2013/055165

§ 371 Date: Dec. 23, 2015

(51) Int. Cl. A01G 3/04

(52) U.S. Cl. CPC A01G 3/04

(57) ABSTRACT

Disclosed is a double blade bar for pruning and pollarding, including a supporting framework for a cutting blade and a counter-chop blade extending along a cutting direction, interconnected each other and being operable in alternating rectilinear movement, in opposite direction one another, along the cutting direction, passing from an open configuration of the bar in which the cutting teeth overlap the counter-chop teeth, to a closed configuration wherein each of the cutting teeth is located in a substantially intermediate position with respect to the port defined by two successive counter-chop teeth, and vice versa. The bar also includes a movement transmission unit which present, on the cutting blade, an upper rack which engages, by way of a cogwheel, a corresponding lower rack associated to the counter-chop blade. The wheel is pivoted on a supporting rod around a pivoting axis and driven by a motor.

### TECHNICAL FIELD

The present invention relates to a double blade bar for pruning and pollarding, particularly for olive tree groves, citrus groves, hedges, timber trees and similar.

### BACKGROUND ART

At the state of the art, bars for pruning and pollarding have a supporting framework for a cutting blade driven by a motor. The blade has teeth and moves along its development direction in an alternating manner between a lower stop and an upper stop. The framework is normally connected to a mechanical arm carried by a tractor means.

This type of bars normally have dimensions which provide lengths of between 2 and 3 meters and have a cutting capacity of up to 80 mm. diameter of the branch.

The alternative movement of the blade is given by a hydraulic motor which drives an eccentric pin.

The bar is mounted on tractor means where the operator is able to actuate the movements of the mechanical arm to allow horizontal and vertical movements and to vary the inclination of the cutting bar.

The control devices are generally constituted by levers, which operate the hydraulic distributors.

Despite the fact that this device has a good cut, however, with branches that have a larger diameter or that oppose greater resistance, binding problems may occur.

For this reason, the branch to be cut can break suddenly causing an endangerment for the plant and can induce working slowdowns.

In addition, a not accurate cutting action involves some risks even for the operator who, although adequately protected inside the passenger compartment of the tractor, may lose control of the vehicle for some moments.

To overcome these problems, it is thought to double blade bars with a second counter-chop blade in respect to the first blade.

However, this type of bars have operating problems depending on what they have to cut, branches, bushes, small diameter branches, large diameter branches, etc.

Moreover, due to the loads to which the internal mechanism is subjected, these bars have weak broken with inconvenience and costs that this entails.

Finally, not always this type of bar has an effective yield.

### DISCLOSURE OF THE INVENTION

The aim of the invention is to eliminate the drawbacks described above in known types of blade bars, and to realize a double blade bar, for pruning and pollarding, which do not present problems of binding for any type of cut, and on the contrary, it allows clean cuts of bushes, fronds, vines, olive trees, oaks and branches of trees of any size.

Within the above aim, a purpose of the present invention is to provide a double blade bar that is reliable and effective, and which provides a long lifetime of its components avoiding breakage of the weak type.

Another purpose of the double blade bar for pruning and pollarding, particularly for olive tree groves, citrus groves, hedges, timber trees and is similar, is to ensure the best performance possible in any use it is employed.

Not the last purpose of the invention is to provide a double blade bar, particularly for pruning and pollarding of olive tree groves, citrus groves, hedges, timber trees and similar, with means readily available in commerce and using materials of common use, so that the device is economically competitive.

This aim, these and other objects that will become better apparent hereinafter, are achieved by a double blade bar, particularly for pruning and pollarding of olive tree groves, citrus groves, hedges, timber trees and similar, according to the invention, comprising:
a supporting framework for a cutting blade and a counter-chop blade extending along a cutting direction, interconnected each other and arranged to be operated in alternating rectilinear movement, in the opposite direction to one another, along said cutting direction, passing from an open configuration of the bar in which the cutting teeth of said cutting blade overlap the counter-chop teeth of said counter-chop blade, to a closed configuration of the bar in which each of said cutting teeth is in a position substantially intermediate with respect to the span defined by two successive teeth of said counter-chop teeth, and vice versa,
movement transmission means having at least an upper rack, associated with at least a portion of said cutting blade, which engages with a corresponding lower rack, associated with at least a portion of said counter-chop blade by means of a cogwheel which is interposed between said upper rack and said lower rack, pivoted on a supporting rod around a pivoting axis and driven by motor means, so that, in said open configuration of the bar, said cogwheel engages, on the one hand, with a portion of said substantially median upper rack and, on the other side, with a substantially median portion of said lower rack, while in said closed configuration of the bar, said cogwheel engages with a first external portion of said upper rack and, simultaneously, with a second external portion of said lower rack, said second external portion being anti-symmetric to said first portion with respect to said pivoting axis.

### BRIEF DESCRIPTION OF THE DRAWINGS

Further characteristics and advantages of the invention will become apparent from the description of a preferred but not exclusive embodiment of the double blade bar, particularly for pruning and pollarding of olive tree groves, citrus groves, hedges, timber trees and similar, illustrated by way of indicative and not limitative example in the accompanying drawings in which:

FIG. 1 is a portion of the double blade bar in elevation represented respectively in an open configuration with the cutting teeth overlapping the counter-chop teeth and in a closed configuration in which each of the cutting teeth is in a substantially intermediate position with respect to the span defined by two successive counter-chop teeth;

FIG. 2 is a first embodiment of the double blade bar, with an enlargement of motor means;

FIG. 3 shows the section of the previous figure;

FIG. 4 illustrates two enlarged details of the transmission means of the double blade bar respectively in the open and in the closed configuration;

FIG. 5 is a second embodiment of the double blade bar, with an enlargement of motor means;

FIG. 6 shows the section VI-VI of the previous figure;

FIG. 7 illustrates the rotating cam with first and second bearing, motor means of the second embodiment of FIGS. 5 and 6;

FIG. 8 is the third variation of the double blade bar.

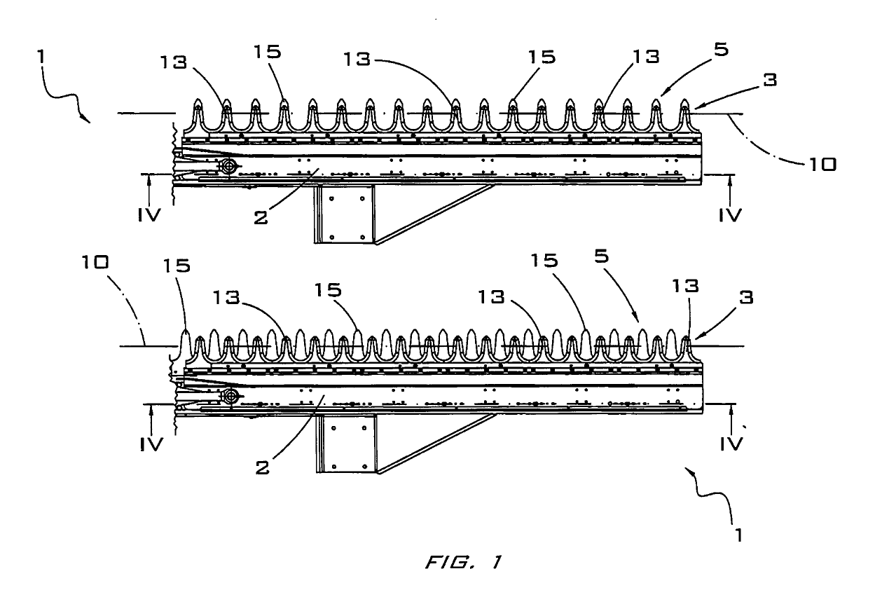

### MODES FOR CARRYING OUT THE INVENTION

With reference to the above figures, the double blade bar, particularly for pruning and pollarding of olive tree groves, citrus groves, hedges, timber trees and similar, which is indicated in its entirety with the reference 1, according to the invention, comprises:
a supporting framework 2 for a cutting blade 3 and a counter-chop blade 5 that develop along a cutting direction 10, which are interconnected and which are arranged to be operated in alternating rectilinear movement, in the opposite direction one another, along the cutting direction 10, passing from an open configuration of the bar in which cutting teeth 13 of the blade 3 overlap counter-chop teeth 15 of the blade 5, to a closed configuration in which each of teeth 13 is located in a substantially intermediate position with respect to the span defined by two successive teeth 15, and vice versa,
transmission means of the alternating rectilinear movement of blades 3 and 5 having at least one upper rack 6, associated with at least a portion of the blade 3, which engages with a corresponding lower rack 8, associated with at least a portion of the blade 5, by means of a cogwheel 7, which is interposed between racks 6 and 8 and which is pivoted on a supporting rod 9 around a pivoting axis 20 and which is controlled by motor means. Racks 6 and 8 are arranged to move in a way that, in the open configuration of the bar, the cogwheel 7 engages, on one hand with a substantially median portion of the rack 6, on the other hand, with a substantially median portion of the rack 8, while, in the closed configuration of the bar, the wheel 7 must engage with a first external portion of the rack 6 and, simultaneously, with a second external portion of the rack 8. This second external portion of the rack 8 is also anti-symmetric to the first portion, with respect to the pivoting axis 20 of the cogwheel 7.

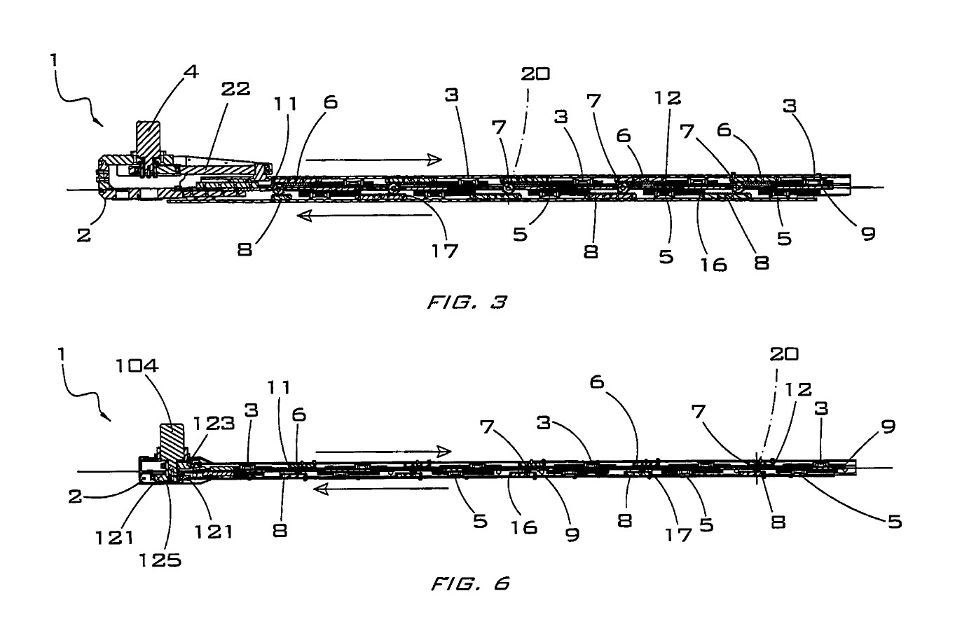

In practice, with reference to FIGS. 3, 4 and 6, the cutting is caused by the alternating movement of racks 6 and 8: for each displacement X of the upper rack 6 an identical feed X of the cutting blade 3 along the cutting direction 10 occurs and simultaneously, but in opposite direction, a similar advancement X′ along the cutting direction 10 of the counter-chop blade 5 occurs, caused by the displacement X′ of the lower racks 8. And vice versa.

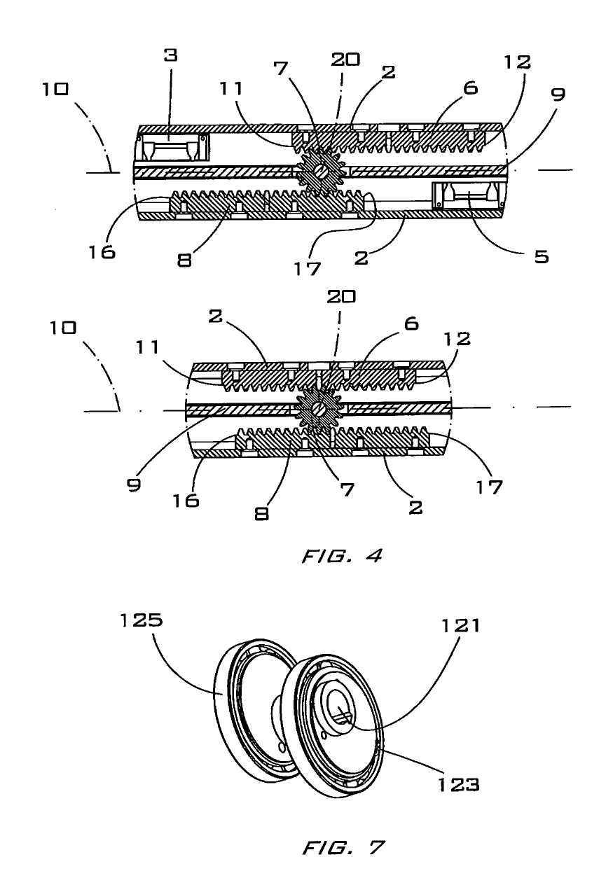

Preferably, racks 6 and 8 respectively comprise a first right stop 11 and a first left stop 12, and a second left stop 16 and a second right stop 17, so that, during the rectilinear movement of the cutting blade 3 and counter-chop blade 5, the bar passes alternately from a first position to a second position of the closed configuration (FIG. 4). In the first position, the cogwheel 7 engages simultaneously with a first external portion of the rack 6 close to the stop 11 and with a second external portion of the rack 8 next to the stop 17, while in the second position, the cogwheel 7 engages simultaneously with a first external portion of the rack 6 close to the stop 12 and a second external portion of the rack 8 close to the stop 16.

In practice, the cogwheel 7 moves, engaging with racks 6 and 8 which respectively bring along the cutting blade 3 and the counter-chop blade 5, between the two pairs of stops (11-12 and 16-17), varying the span between teeth 13 and 15. In correspondence of the median portion of racks 6 and 8, when teeth 13 and 15 of the cutting blade 3 and of the counter-chop blade 5 overlap, it would be obtained the close position of the span and the cut of the branch.

Advantageously, it is provided a series of double racks, comprising a plurality of upper racks associated to the blade 3 which face on as many lower racks associated to the blade 5, identical or similar to racks 6 and 8, in which each element of the series is integrally and respectively associated to different portions of the blade 3 and 5. The number of racks 6 and 8 of each set is in function of the length of the blade and can vary from four to six pairs of racks 6 and 8 for light bars, for cutting branches and bushes, or for heavy bars arranged to cut branches with important diameter.

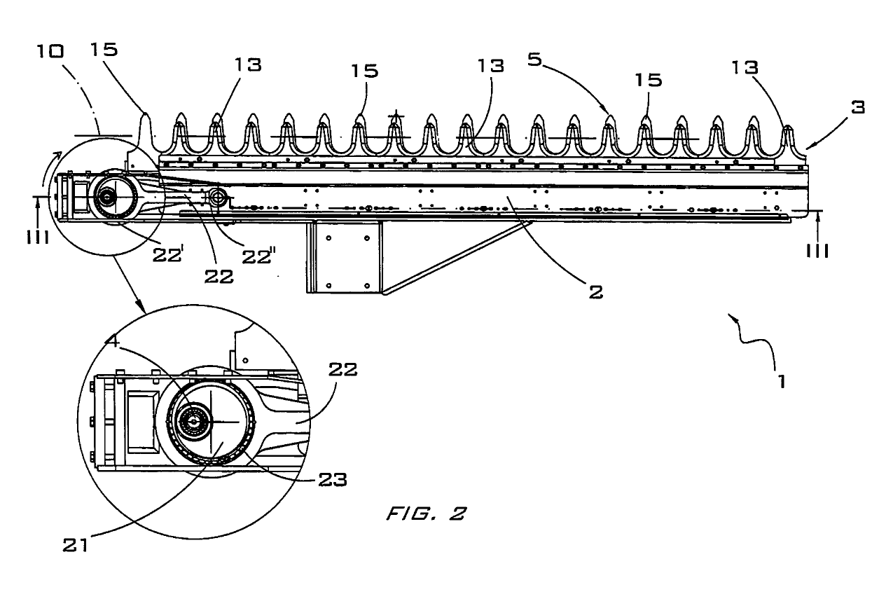

In a first embodiment, motor means comprise an eccentric flywheel 21 driven in flat circular movement by a hydraulic motor 4 and which engages with a first end 22′ of a connecting rod 22, which presents the second end 22′ connected to the cutting blade 3 (FIG. 2).

Between the flywheel 21 and the connecting rod 22 is preferably provided a connection bearing 23.

In this way, the upper rack 6 moves alternately along the direction 10 and, thanks to the cogwheel 7 actuates the lower rack 8 that, moving in the opposite direction with respect to the rack 6, allows the alternating rectilinear movement of the blades 13 and 15 one in the opposite direction to the other.

Obviously, it is possible that the second end 22″ of the connecting rod 22 is connected to the blade 5, with a similar operation compared as previously described.

This first variation allows the cutting of diameters between about 0 and 50 mm.

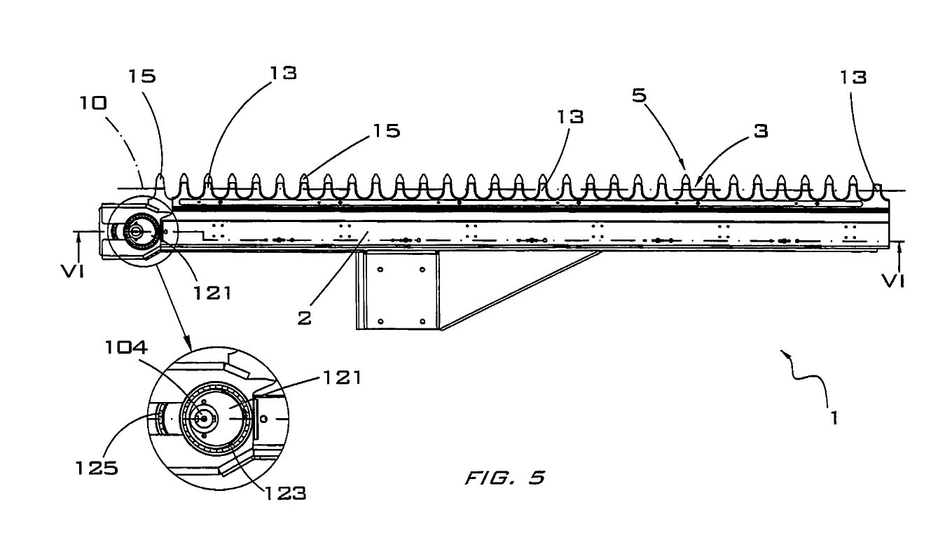

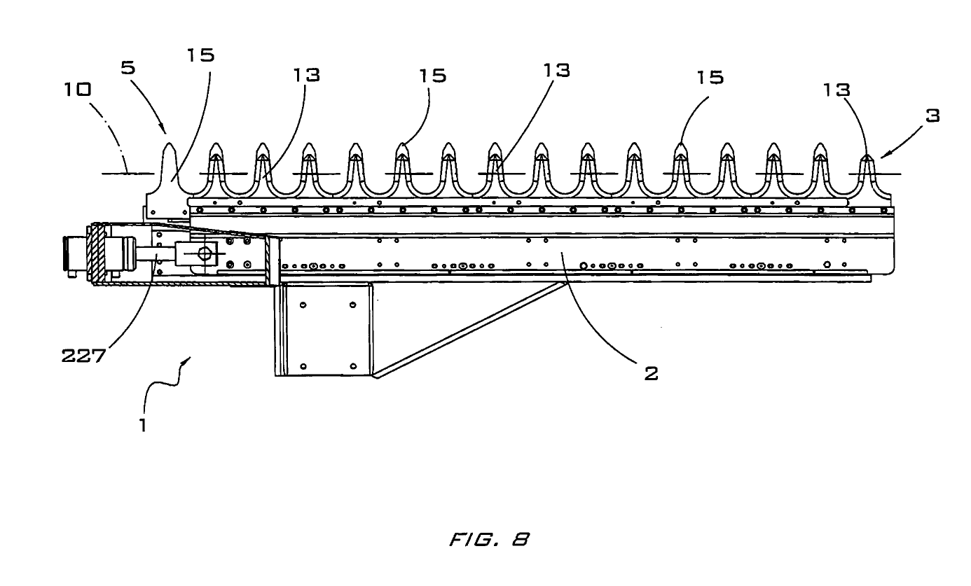

With reference to FIGS. 5 and 6, another embodiment provides that motor means include a cam 121 driven in rotation by a hydraulic motor 104, whose driveshaft is arranged to be coupled with said cam 121, and alternately pushing said blades 3 and 5 respectively by means of a first bearing 123 and a second bearing 125, mounted eccentrically on two distinct portions of the cam 121 (FIG. 7).

Bearings 123 and 125, operated in an eccentric rotation around the axis of symmetry of the cam 121, associated with it, in an alternating manner push respectively the blade 3 and the blade 5, allowing the alternate movement.

The drive of racks 6 and 8 similarly to what occurs in the first solution here presented, makes move blades 3 and 5 in opposite direction.

These motor means are arranged to light bar, designed for cutting small diameters, such as branches of fronds, bushes and the pruning of vines.

This alternative solution has a cutting capacity substantially included between 0 and 20 mm.

A third embodiment (FIG. 8) provides that motor means comprise a cylinder 227, for example hydraulic, pushing the cutting blade 3: thanks to the rectilinear alternating movement of the blade 3, the upper rack 6 associated to it, makes move the wheel 7 which, engaging on the lower rack 8, produces the movement in the opposite direction of the counter-chop blade 5, to which it is associated.

Obviously, it is possible that the cylinder 227, instead of pushing the blade 3, acts on the counter-chop blade 5, with a similar operation as that one just described.

This third embodiment, allows the pruning and pollarding of diameters between at about 0 and 80 mm.

From the above description it is thus evident that the invention achieves the intended aim and proposed objects and in particular it is underlined the fact that it is achieved a double blade bar, particularly for pruning and pollarding of olive tree groves, citrus groves, hedges, timber trees and similar, that allows to have a clean and precise cut without binding problems.

In particular, the fact of having a counter-chop blade that, acting synergistically with the cutting blade, cuts the branch to be pruned or pollarded, ensures a clean cut without risk of binding.

Another advantage of the invention is the fact that the device allows the realization of a double blade bar reliable and effective, thus avoiding the risk of overturning the tractor and allows the operator to work safely.

Another advantage of the invention is the fact that, thanks to the movement of the blades, the device is very effective and fast in the cutting action. Furthermore, the activation of the counter-chop blade on the cutting blade (and vice versa) simulates the manual cutting, giving the plant considerable benefits and the operator a considerable safety.

Another advantage of the bar, according to the invention, is to provide a device with a large cutting capacity, allowing the user the choice of the most suitable solution to his needs in a wide range of embodiments.

Not least, the use of means readily available in the market and the use of common materials, make the device economically competitive.

The invention thus conceived is susceptible of numerous modifications and variations, all falling within the inventive concept.

Moreover, all the details may be replaced with other technically equivalent elements.

In practice, the materials employed, as well as the dimensions, may be any according to requirements, provided they are consistent with the purpose of realization.

1. A double blade bar, particularly for pruning and pollarding of olive tree groves, citrus groves, hedges, timber trees and similar, comprising:
a support framework (2) for a cutting blade (3) and a counter-chop blade (5) extending along a cutting direction (10), interconnected and adapted to be operated in alternating rectilinear movement, in opposite sense to one another, along said cutting direction (10), passing from an open configuration of the bar in which the cutting teeth (13) of said cutting blade (3) overlap the counter-chop teeth (15) of said counter-chop blade (5), to a closed configuration of the bar in which each of said cutting teeth (13) is in a substantially intermediate position with respect to the span defined by two successive teeth of said counter-chop teeth (15), and vice versa,
movement transmission means having at least an upper rack (6), associated with at least a portion of said cutting blade (3), engaging with a corresponding lower rack (8), associated with at least a portion of said counter-chop blade (5) by means of a cogwheel (7) interposed between said upper rack (6) and said lower rack (8), pivoted on a support rod (9) around a pivoting axis (20) and driven by motor means, so that in said open configuration of the bar said cogwheel (7) engages, on one hand, with a substantially median portion of said upper rack (6) and, on the other side, with a substantially median portion of said lower rack (8), while in said closed configuration of the bar, said cogwheel (7) engages with a first external portion of said upper rack (6) and, simultaneously, with a second external portion of said lower rack (8), said second external portion being anti-symmetric to said first portion with respect to said pivoting axis (20).

2. The bar according to claim 1, wherein said upper rack (6) and said lower rack (8) comprise respectively a first right stop (11) and a first left stop (12), and a second left stop (16) and a second right stop (17), so that during said rectilinear movement of the cutting blade (3) and of said counter-chop blade (5), the bar alternately passes from a first position to a second position of said configuration closed, wherein, in said first position, said cogwheel (7) engages simultaneously with a first external portion of said upper rack (6) close to said first left stop (11) and with a second external portion of said lower rack (8) close to said second right stop (17), while, in said second position, said cogwheel (7) engages simultaneously with a first external portion of said upper rack (6) close to said first right stop (12) and with a second external portion of said lower rack (8) close to said second left stop (16).

3. The bar according to claim 1, wherein a series of double racks, comprising a plurality of upper racks which face on as many lower racks, wherein each element of said series is integrally associated with different portions of said cutting blade (3) and of said counter-chop blade (5).

4. The bar according to claim 1, wherein said motor means comprise an eccentric flywheel (21) actuated in flat circular movement by a hydraulic motor (4) and engages with a connecting rod (22) connected to said cutting blade (3), and further comprise a connection bearing (23) interposed between said eccentric flywheel (21) and said connecting rod (22).

5. The bar according to claim 1, wherein said motor means comprise a cam (121) driven in rotation by a hydraulic motor (104) having a driveshaft coupled to said cam (121) and alternately pushing said cutting blade (3) and said counter-chop blade (5) respectively, by means of a first bearing (123) and a second bearing (125), said first bearing (123) and said second bearing (125) being mounted eccentrically on two distinct portions of said cam (121), being driven in eccentric rotation around the axis of symmetry of said cam (121) and pushing alternately said cutting blade (3) and said counter-chop blade (5) allowing the alternate movement.

6. The bar according to claim 1, wherein said motor means comprise a cylinder (227) pushing said cutting blade (3), so that, thanks to the rectilinear alternating movement of said cutting blade (3), said upper rack (6) makes move said cogwheel (7) which, engaging on said lower rack (8), produces the movement in the opposite direction of said counter-chop blade (5).

7. The bar according to claim 2, wherein a series of double racks, comprising a plurality of upper racks which face on as many lower racks, wherein each element of said series is integrally associated with different portions of said cutting blade (3) and of said counter-chop blade (5).

8. The bar according to claim 2, wherein said motor means comprise an eccentric flywheel (21) actuated in flat circular movement by a hydraulic motor (4) and engages with a connecting rod (22) connected to said cutting blade (3), and further comprise a connection bearing (23) interposed between said eccentric flywheel (21) and said connecting rod (22).

9. The bar according to claim 3, wherein said motor means comprise an eccentric flywheel (21) actuated in flat circular movement by a hydraulic motor (4) and engages with a connecting rod (22) connected to said cutting blade (3), and further comprise a connection bearing (23) interposed between said eccentric flywheel (21) and said connecting rod (22).

10. The bar according to claim 7, wherein said motor means comprise an eccentric flywheel (21) actuated in flat circular movement by a hydraulic motor (4) and engages with a connecting rod (22) connected to said cutting blade (3), and further comprise a connection bearing (23) interposed between said eccentric flywheel (21) and said connecting rod (22).

11. The bar according to claim 2, wherein said motor means comprise a cam (121) driven in rotation by a hydraulic motor (104) having a driveshaft coupled to said cam (121) and alternately pushing said cutting blade (3) and said counter-chop blade (5) respectively, by means of a first bearing (123) and a second bearing (125), said first bearing (123) and said second bearing (125) being mounted eccentrically on two distinct portions of said cam (121), being driven in eccentric rotation around the axis of symmetry of said cam (121) and pushing alternately said cutting blade (3) and said counter-chop blade (5) allowing the alternate movement.

12. The bar according to claim 3, wherein said motor means comprise a cam (121) driven in rotation by a hydraulic motor (104) having a driveshaft coupled to said cam (121) and alternately pushing said cutting blade (3) and said counter-chop blade (5) respectively, by means of a first bearing (123) and a second bearing (125), said first bearing (123) and said second bearing (125) being mounted eccentrically on two distinct portions of said cam (121), being driven in eccentric rotation around the axis of symmetry of said cam (121) and pushing alternately said cutting blade (3) and said counter-chop blade (5) allowing the alternate movement.

13. The bar according to claim 4, wherein said motor means comprise a cam (121) driven in rotation by a hydraulic motor (104) having a driveshaft coupled to said cam (121) and alternately pushing said cutting blade (3) and said counter-chop blade (5) respectively, by means of a first bearing (123) and a second bearing (125), said first bearing (123) and said second bearing (125) being mounted eccentrically on two distinct portions of said cam (121), being driven in eccentric rotation around the axis of symmetry of said cam (121) and pushing alternately said cutting blade (3) and said counter-chop blade (5) allowing the alternate movement

14. The bar according to claim 7, wherein said motor means comprise a cam (121) driven in rotation by a hydraulic motor (104) having a driveshaft coupled to said cam (121) and alternately pushing said cutting blade (3) and said counter-chop blade (5) respectively, by means of a first bearing (123) and a second bearing (125), said first bearing (123) and said second bearing (125) being mounted eccentrically on two distinct portions of said cam (121), being driven in eccentric rotation around the axis of symmetry of said cam (121) and pushing alternately said cutting blade (3) and said counter-chop blade (5) allowing the alternate movement

15. The bar according to claim 8, wherein said motor means comprise a cam (121) driven in rotation by a hydraulic motor (104) having a driveshaft coupled to said cam (121) and alternately pushing said cutting blade (3) and said counter-chop blade (5) respectively, by means of a first bearing (123) and a second bearing (125), said first bearing (123) and said second bearing (125) being mounted eccentrically on two distinct portions of said cam (121), being driven in eccentric rotation around the axis of symmetry of said cam (121) and pushing alternately said cutting blade (3) and said counter-chop blade (5) allowing the alternate movement

16. The bar according to claim 9, wherein said motor means comprise a cam (121) driven in rotation by a hydraulic motor (104) having a driveshaft coupled to said cam (121) and alternately pushing said cutting blade (3) and said counter-chop blade (5) respectively, by means of a first bearing (123) and a second bearing (125), said first bearing (123) and said second bearing (125) being mounted eccentrically on two distinct portions of said cam (121), being driven in eccentric rotation around the axis of symmetry of said cam (121) and pushing alternately said cutting blade (3) and said counter-chop blade (5) allowing the alternate movement

17. The bar according to claim 10, wherein said motor means comprise a cam (121) driven in rotation by a hydraulic motor (104) having a driveshaft coupled to said cam (121) and alternately pushing said cutting blade (3) and said counter-chop blade (5) respectively, by means of a first bearing (123) and a second bearing (125), said first bearing (123) and said second bearing (125) being mounted eccentrically on two distinct portions of said cam (121), being driven in eccentric rotation around the axis of symmetry of said cam (121) and pushing alternately said cutting blade (3) and said counter-chop blade (5) allowing the alternate movement.

18. The bar according to claim 2, wherein said motor means comprise a cylinder (227) pushing said cutting blade (3), so that, thanks to the rectilinear alternating movement of said cutting blade (3), said upper rack (6) makes move said cogwheel (7) which, engaging on said lower rack (8), produces the movement in the opposite direction of said counter-chop blade (5).

19. The bar according to claim 3, wherein said motor means comprise a cylinder (227) pushing said cutting blade (3), so that, thanks to the rectilinear alternating movement of said cutting blade (3), said upper rack (6) makes move said cogwheel (7) which, engaging on said lower rack (8), produces the movement in the opposite direction of said counter-chop blade (5).

20. The bar according to claim 4, wherein said motor means comprise a cylinder (227) pushing said cutting blade (3), so that, thanks to the rectilinear alternating movement of said cutting blade (3), said upper rack (6) makes move said cogwheel (7) which, engaging on said lower rack (8), produces the movement in the opposite direction of said counter-chop blade (5).
